(19) United States
(12) Patent Application Publication
(10) Pub. No.: US 2026/0070323 A1
(43) Pub. Date: Mar. 12, 2026

(54) SEPARATION OF MUTILAYER STRUCTURES

(71) Applicant: THE PROVOST, FELLOWS, FOUNDATION SCHOLARS, AND THE OTHER MEMBERS OF BOARD, OF, Dublin (IE)

(72) Inventors: Mukesh Prabhakar PEDNEKAR, Dublin (IE); Mukesh Prabhakar PEDNEKAR, Dublin (IE)

(21) Appl. No.: 19/108,690

(22) PCT Filed: Sep. 4, 2023
(86) PCT No.: PCT/EP2023/074152

§ 371 Date: Mar. 4, 2025

(30) Foreign Application Priority Data
Sep. 5, 2022 (GB) 2212897.9

(51) Int. Cl. B32B 43/00

(52) U.S. Cl. CPC B32B 43/006; B32B 2311/24

(57) ABSTRACT

A method for separating a first layer from a second layer in a multilayer structure is disclosed. The method comprises the step of contacting the multilayer structure with a treatment solution comprising a solvent and a non-solvent until the first layer is separated from the second layer. The first layer comprises a polymer, wherein the polymer is soluble in the solvent and the polymer is insoluble in the non-solvent. The separated layer, an article comprising the separated layer, and a use of the treatment solution to separate the first layer from the second layer in the multilayer structure are also disclosed.

### FIELD

The present invention relates to a method of separating a polymer layer from a multilayer structure. The present invention also relates to layers separated by such a method, articles comprising such layers, and a use of a treatment solution for separating polymer layers from a multilayer structure.

### BACKGROUND

Multi-layered plastic packaging is widely used in the food and pharmaceutical industry such as pharmaceutical blister packaging and crisp packets. Generally, these multilayer structures are composed of polymers, such as polypropylene (PP), polyethylene (PE), polyvinyl chloride (PVC), and polyethylene terephthalate (PET), bound with paper or metal layers (e.g. aluminium) using adhesives. Multilayer structures which combine polymers with other materials enhance the mechanical and barrier properties of the packaging and thus prolong the shelf-life of the contents. However, due to the complex structure of these multilayer structures they are difficult to separate or recycle. As a result, they are generally disposed of in landfills or by incineration, leading to environmental pollution (such as by generation of greenhouse gases) and the loss of valuable resources.

Traditional plastic mechanical recycling involves shredding, milling plastic waste, and recovery of polymer particles through a series of sieving and centrifugation methods, which is impossible with multilayer packaging. Different processes have been proposed for separating polymers from multilayer structures. Some processes involve the delamination and/or dissolution of polymers using organic solvents, organic acids and/or inorganic acids and recovering the polymers by various precipitation, filtration and/or evaporation methods. Commonly used organic solvents include benzene, dichloromethane, xylene, toluene, carbon tetrachloride and chloroform. Other processes involve the degradation of polymers by enzymes into monomers or oligomers. Still other processes involve ionic liquids and deep eutectic solvents for polymer recovery.

### SUMMARY

It is one aim of the present invention, amongst others, to provide a method of separating layers in multilayer structures that addresses at least one disadvantage of the prior art, whether identified here or elsewhere, or to provide an alternative to existing methods of separating layers in multilayer structures. For instance, it may be an aim of the present invention to provide a method of separating layers in multilayer structures which is simple and energy efficient.

According to aspects of the present invention, there is provided a method, a separated layer, an article and a use as set forth in the appended claims. Other features of the invention will be apparent from the dependent claims, and the description which follows.

According to a first aspect of the present invention, there is provided a method for separating a first layer from a second layer in a multilayer structure, the method comprising the steps of providing a multilayer structure having at least two layers including a first layer and a second layer, and contacting the multilayer structure with a treatment solution comprising a solvent and a non-solvent until the first layer is separated from the second layer, wherein the first layer comprises a polymer, wherein the polymer is soluble in the solvent and the polymer is insoluble in the non-solvent.

The inventors have surprisingly found that a treatment solution comprising a solvent and a non-solvent may be used to separate a polymer layer from another layer in a multilayer structure. The method of the present invention advantageously does not dissolve or degrade the polymer layer in the multilayer structure, in contrast to methods where a solvent alone is used. This facilitates recovery of the polymer layer since secondary recovery systems, such as precipitation or evaporation, are not required and improves the quality of the recovered polymer. The method of the present invention also facilitates the recovery of the other layer(s) in the multilayer structure, and the treatment solution may advantageously also be recovered and reused. Furthermore, the method may be carried out under mild conditions which makes the method safer, more energy efficient and more environmentally friendly.

It is believed that the treatment solution may cause separation of the polymer layer in the multilayer structure by swelling the polymer layer. The presence of the non-solvent in the treatment solution is believed to prevent the solvent from dissolving the polymer layer, but still allow the solvent to swell the polymer layer, Separation of the polymer layer from another layer is believed to begin at the interface between the layers which is in contact with the treatment solution. As the layers separate, it is believed that more of the interface comes into contact with the treatment solution until the layers are completely separated.

The multilayer structure is a structure containing at least two layers therein. The multilayer structure described herein comprises at least a polymer layer and may alternatively be referred to as a polymer composite structure. The multilayer structure may have any suitable shape and any suitable arrangement of layer therein. The first layer and the second layer are suitably bonded to each other. The method of the first aspect may be a method of delaminating the first layer and the second layer in the multilayer structure.

The first layer comprises a polymer. The polymer in the first layer may be referred to as the first polymer. The first layer may be a film of the first polymer. The first polymer may be any suitable polymer, for example a polymer used in multilayer packaging. The first polymer suitably comprises a polyolefin or a polyester. The first polymer suitably comprises at least carbon atoms and hydrogen atoms, and may comprise further atoms such as oxygen atoms and halogen (preferably chlorine) atoms. Examples of suitable polymers include polyethylene, polypropylene, polyvinyl chloride, polyvinylidene chloride, polychlorotrifluoroethylene, ethylene vinyl acetate, ethylene vinyl alcohol, polyamide and polyethylene terephthalate. The polyethylene may be selected from low-density polyethylene, linear low-density polyethylene and high-density polyethylene. The first layer suitably comprises polyethylene, polypropylene, polyvinyl chloride, polyvinylidene chloride or polyethylene terephthalate. The first layer preferably comprises polyethylene (preferably low-density polyethylene), polyvinyl chloride or polyvinylidene chloride.

The second layer is preferably different from the first layer. The second layer may comprise a polymer or a non-polymer.

The second layer may comprise a polymer. The polymer in the second layer may be referred to as the second polymer. The second layer may be a film of the second polymer. The second polymer may be any suitable polymer, for example a polymer used in combination with another polymer in multilayer packaging. Preferably, the second polymer is different from the first polymer. The second polymer suitably comprises a polyolefin or a polyester. The second polymer suitably comprises at least carbon atoms and hydrogen atoms, and may comprise further atoms such as oxygen atoms and halogen (preferably chlorine) atoms. Examples of suitable polymers include polyethylene, polypropylene, polyvinyl chloride, polyvinylidene chloride, polychlorotrifluoroethylene, ethylene vinyl acetate, ethylene vinyl alcohol, polyamide and polyethylene terephthalate. The polyethylene may be selected from low-density polyethylene, linear low-density polyethylene and high-density polyethylene. The second layer suitably comprises polyethylene, polypropylene, polyvinyl chloride, polyvinylidene chloride or polyethylene terephthalate.

In some embodiments, the first layer comprises polyethylene, preferably low-density polyethylene, and the second layer comprises polypropylene.

The second layer may comprise a non-polymer. The non-polymer suitably comprises metal or paper. The non-polymer may comprise metal, preferably aluminium. The second layer may be metal foil, such as aluminium foil. The non-polymer may comprise paper, such as cardboard.

In some embodiments, the first layer comprises polyvinyl chloride or polyvinylidene chloride and the second layer comprises metal, preferably aluminium. In such an embodiment, the multilayer structure suitably does not comprise paper.

In some embodiments, the first layer comprises polyethylene, preferably low-density polyethylene, and the second layer comprises paper. In such an embodiment, the multilayer structure suitably does not comprise metal.

The multilayer structure may comprise one or more further layers, i.e. in addition to the first and second layer. For example, the multilayer structure may comprise a third layer. Suitable features of the further (e.g. third) layer are as defined in relation to the second layer. Preferably, the third layer is different to the first layer and the second layer. The multilayer structure may have any suitable arrangement of the first layer, second layer and third layer. The multilayer structure may comprise the first layer, second layer and third layer in that order, or in any other order, such as the second layer, first layer and third layer, or the first layer, third layer and second layer. For example, the second layer may be in between the first layer and the third layer. Alternatively, the first layer may be in between the second layer and the third layer, or the third layer may be in between the first layer and the second layer.

In some embodiments, the first layer comprises polyethylene, preferably low-density polyethylene, the second layer comprises polypropylene, and the third layer comprises metal. Preferably, the first layer comprises low-density polyethylene, the second layer comprises polypropylene, and the third layer comprises aluminium. In such an embodiment, the multilayer structure suitably does not comprise paper.

In some embodiments, the second layer comprises metal and the third layer comprises paper. Suitably, the first layer comprises polyethylene, the second layer comprises metal and the third layer comprises paper. Preferably, the first layer comprises low-density polyethylene, the second layer comprises aluminium and the third layer comprises paper.

The multilayer structure may comprise an adhesive layer. The adhesive layer may bond two or more layers (e.g. the first layer, the second layer, and/or any further layer) in the multilayer structure together. The multilayer structure may comprise more than one adhesive layer. The adhesive layer comprises an adhesive. Suitable adhesives will be well known to the person skilled in the art. Suitably, the adhesive comprises an adhesive polymer, such as an acrylic adhesive, starch, vinyl acetate, vinyl alcohol, ethylene vinyl alcohol, or polyurethane. Preferably, the adhesive comprises polyurethane.

The multilayer structure may comprise a printed ink. The printed ink suitably comprises a dye and/or a pigment. Preferably, the printed ink comprises a pigment.

The multilayer structure is suitably multilayer packaging, or an offcut thereof. Different types of multilayer packaging will be known to the person skilled in the art. Examples of suitable multilayer packaging include blister packs (for example, for medicinal products), food packets, and food or drink cartons.

The multilayer structure may be a blister pack or an offcut thereof. Blister packs may be used for packaging health or medicinal products such as tablets and capsules. Blister packs typically comprise a polymer layer and metal layer, suitably bonded by an adhesive layer. For example, the blister pack may comprise a layer comprising polyvinyl chloride or polyvinylidene chloride, and aluminium foil. The aluminium foil is suitably bonded to the layer comprising polyvinyl chloride or polyvinylidene chloride by an adhesive layer comprising an adhesive polymer. The blister pack may comprise a layer comprising polyvinyl chloride, a layer comprising polyvinylidene chloride, and aluminium foil. Suitably, the layer comprising polyvinylidene chloride is an inner layer and the layer comprising polyvinyl chloride is an outer layer. The blister pack may comprise a printed ink, suitably on the metal layer (e.g. aluminium foil).

The multilayer structure may be a food packet or an offcut thereof. Food packets may be used to seal food items away from air, light and moisture. Food packets are suitably used for packaging snacks. For example, the food packet may be a packet for crisps or potato chips. Food packets typically comprise a polymer layer and metal layer. For example, the food packet may comprise a polyethylene layer and/or a polypropylene layer and an aluminium layer. The food packet may comprise a printed ink.

The multilayer structure may comprise a food or drink carton or an offcut thereof. Food or drink cartons are typically stronger and less susceptible to rupture than food packets. The food or drink carton may comprise a polymer layer, such as a polyethylene layer, and paper. The food or drink carton may additionally comprise metal foil, such as aluminium foil. The food or drink carton may comprise a printed ink.

Suitably, the multilayer structure is an offcut of multilayer packaging. Multilayer packaging is typically manufactured using large sheets of a multilayer structure which are cut into individual pieces of packaging. However, this often results in offcuts of excess multilayer structure which cannot be incorporated into the packaging and would otherwise be discarded. The method of the present invention may advantageously be used to recycle such offcuts by separating polymer layers from other layers therein. Polymer layers and other layers separated from such offcuts may be particularly desirable as they are typically in better condition than layers separated from pre-used packaging. For example, polymer layers separated from offcuts may have a similar quality as virgin polymer.

The method of the first aspect comprises contacting the multilayer structure with a treatment solution comprising a solvent and a non-solvent.

The first polymer is soluble in the solvent. Preferably, the first polymer is soluble in the solvent at the temperature of the treatment solution which is contacted with the multilayer structure. The first polymer may have a solubility of at least 0.1 g/L, such as at least 1 g/L, for example at least 10 g/L in the solvent at the temperature of the treatment solution.

The first polymer is insoluble in the non-solvent. Preferably, the first polymer is insoluble in the non-solvent at the temperature of the treatment solution which is contacted with the multilayer structure. The first polymer may have a solubility of up to 0.1 g/L, such as up to 0.01 g/L, for example up to 0.001 g/L in the non-solvent at the temperature of the treatment solution.

Suitably, when other polymers are present in the multilayer structure, said polymers are also soluble in the solvent and insoluble in the non-solvent.

The second polymer, when present, is suitably soluble in the solvent. Preferably, the second polymer is soluble in the solvent at the temperature of the treatment solution which is contacted with the multilayer structure. The second polymer may have a solubility of at least 0.1 g/L, such as at least 1 g/L, for example at least 10 g/L in the solvent at the temperature of the treatment solution.

The second polymer, when present, is suitably insoluble in the non-solvent. Preferably, the second polymer is insoluble in the non-solvent at the temperature of the treatment solution which is contacted with the multilayer structure. The second polymer may have a solubility of up to 0.1 g/L, such as up to 0.01 g/L, for example up to 0.001 g/L in the non-solvent at the temperature of the treatment solution.

The adhesive, when present, is suitably soluble in the solvent. Preferably, the adhesive is soluble in the solvent at the temperature of the treatment solution which is contacted with the multilayer structure. The adhesive may have a solubility of at least 0.1 g/L, such as at least 1 g/L, for example at least 10 g/L in the solvent at the temperature of the treatment solution.

The printed ink, when present, is suitably insoluble in the treatment solution. Preferably, on contact of the multilayer structure with the treatment solution the printed ink is released from the multilayer structure (for example, the metal layer) and becomes suspended in the treatment solution. The printed ink may have a solubility of up to 0.1 g/L, such as up to 0.01 g/L, for example up to 0.001 g/L in the treatment solution.

The use of the solvent in the presence of the non-solvent advantageously allows the first layer to separate from other layers in the multilayer structure without dissolution of the polymer in the first layer.

The method of the first aspect preferably does not comprise contacting the multilayer structure with the solvent prior to contacting the multilayer structure with the treatment solution.

The solvent and the non-solvent are preferably miscible. The treatment solution is preferably homogeneous.

The solvent is suitably an organic solvent. The organic solvent is suitably a polar organic solvent, such as a polar protic solvent or a polar aprotic solvent. Examples of suitable solvents include ethanol, n-propanol, isopropanol, acetone, tetrahydrofuran, dimethylformamide, dimethyl sulfoxide, N-methyl-2-pyrrolidone, acetonitrile, and dihydrolevoglucosenone (also known by the trade name Cyrene). Suitably, the solvent comprises isopropanol, dimethyl formamide, and/or dihydrolevoglucosenone. Preferably, the solvent comprises isopropanol or dihydrolevoglucosenone.

Preferably, the solvent comprises dihydrolevoglucosenone. Dihydrolevoglucosenone is a polar aprotic solvent which is biodegradable, and which can be made from renewable sources. Dihydrolevoglucosenone is miscible with water. Using dihydrolevoglucosenone as the solvent has the advantage of making the method of the present invention more environmentally friendly.

The non-solvent is suitably an inorganic solvent. The non-solvent is preferably polar. Preferably, the non-solvent comprises water. The treatment solution may be an aqueous solution. The solvent is preferably miscible with water. Preferably, the treatment solution is an aqueous, homogeneous solution. The water in the treatment solution may be obtained from any suitable source. Suitably, wastewater may be used.

Preferably, the solvent comprises dihydrolevoglucosenone and the non-solvent comprises water.

The treatment solution may comprise the solvent and the non-solvent in a volume ratio of from 95:5 to 5:95, such as from 90:10 to 50:50, preferably from 80:20 to 60:40, such as 70:30. The treatment solution may comprise dihydrolevoglucosenone and water in a volume ratio of from 95:5 to 5:95, such as from 90:10 to 50:50, preferably from 80:20 to 60:40, such as 70:30.

The treatment solution may further comprise an enzyme. Suitably, the enzyme partially hydrolyses the first polymer and/or any further polymer in the multilayer structure, such as the second polymer or the adhesive. The enzyme may comprise a lipase, a cutinase, an esterase, and/or an amidase. The use of an enzyme may advantageously reduce the time needed to separate the first layer from the second layer and/or reduce the amount of solvent required in the treatment solution. Suitably, the enzyme does not substantially degrade the first polymer and/or any further polymer in the multilayer structure. For example, the enzyme is suitably not present in the treatment solution in an amount which causes degradation of the polymer, and/or the treatment solution is not contacted with the multilayer structure for a time sufficient for the enzyme to degrade the polymer. By “substantially degrade” is meant that the solid weight of the polymer is not reduced by more than 20%, such as not more than 15%, preferably not more than 10%.

In some embodiments, the treatment solution is substantially free of, preferably completely free of an enzyme. In such embodiments, the method of the first aspect preferably does not comprise contacting the multilayer structure with an enzyme.

Suitably, the treatment solution is substantially free of, preferably completely free of a carboxylic acid, such as an organic acid, for example an acid. The method of the first aspect preferably does not comprise contacting the multilayer structure with a carboxylic acid, such as an organic acid, for example an acid.

Suitably, the treatment solution contacted with the multilayer structure has a temperature above the glass transition temperature of the first polymer. The treatment solution contacted with the multilayer structure suitably has a temperature above the glass transition temperature of any further polymers in the multilayer structure, such as the second polymer. The treatment solution contacted with the multilayer structure suitably has a temperature below the boiling point of the solvent and the non-solvent.

The treatment solution contacted with the multilayer structure suitably has a temperature of from to 90° C., such as from 20 to 80° C., preferably from 55 to 75° C., for example 60 to 70° C.

The multilayer structure may be contacted with the treatment solution for any suitable length of time. The multilayer structure may be contacted with the treatment solution for at least 1 hour, such as at least 2 hours, for example at least 4 hours. The multilayer structure may be contacted with the treatment solution for 1 to 120 hours, such as from 2 to 24 hours, for example from 4 to 8 hours. The multilayer structure may advantageously be contacted with the treatment solution for a shorter period of time by increasing the temperature of the treatment solution and/or using an enzyme.

The multilayer structure is suitably contacted with the treatment solution in an amount of from 1 to 500 mL, such as from 5 to 100 mL, preferably from 8 to 20 mL of treatment solution per 1 g of the multilayer structure.

The step of contacting the multilayer structure with the treatment solution may involve agitating the treatment solution, for example by stirring.

The method of the first aspect may further comprise the step of cutting the multilayer structure into pieces prior to contacting the multilayer structure with the treatment solution. This may advantageously reduce the time needed to separate the first layer from the second layer. Suitably, the multilayer structure is cut into pieces having a length of from 1 to 100 mm, such as from 5 to 50 mm, for example from 10 to 20 mm.

The first layer and the second layer may be referred to as the “separated first layer” and the “separated second layer” after the separation thereof. The same applies to any further layers, such as the third layer, separated from the multilayer structure.

The method of the first aspect may further comprise the step of removing the treatment solution from the separated first layer and the separated second layer. The treatment solution may be removed by filtration, washing and/or drying of the separated first layer and the separated second layer. Filtration is suitably carried out using a coarse filter. The coarse filter suitably has a pore size smaller than the pieces of the multilayer structure. The coarse filter suitably has a pore size of less than 1 mm, such as less than 0.1 mm. Following removal of the treatment solution, the separated layers are suitably substantially free, preferably completely free of the treatment solution.

In embodiments where the multilayer structure comprises a printed ink, in particular when the ink is printed on a metal layer, contacting the multilayer structure with the treatment solution suitably separates the printed ink from the layers of the multilayer structure. The printed ink suitably becomes suspended in the treatment solution. In such embodiments, method of the first aspect may further comprise the step of removing the printed ink from the treatment solution. The printed ink may be removed by filtration, for example through a fine filter. Examples of fine filters include filter paper, such as Whatman filter paper. The fine filter may have a pore size of up to 15 μm, such as up to 10 μm, for example up to 5 μm.

The removed treatment solution (following the removal of the printed ink if necessary) may be substantially the same as the treatment solution prior to contact with the multilayer structure. The removed treatment solution is suitably substantially free of degradation products from the multilayer structure. The method of the first aspect may further comprise reusing the removed treatment solution. Suitably, the removed treatment solution is reused in a method according to the first aspect of the present invention, i.e. to contact a multilayer structure comprising a first layer and a second layer. Preferably, the removed treatment solution is reused at least twice. Suitably, the treatment solution contacted with the multilayer structure has previously been removed (preferably at least twice) from a separated first layer and a separated second layer according to the first aspect of the present invention. Reusing the treatment solution is environmentally friendly and allows the method of the first aspect to be a circular process.

The method of the first aspect may further comprise the step of isolating the separated first layer from the separated second layer. Suitable techniques for isolating the separated first layer from the separated second layer will be known to a person skilled in the art, based on the identity of the first layer and the second layer. For example, the separated first layer and the separated second layer may be isolated by techniques based on density (such as centrifugation) or static charge.

According to a preferred embodiment, the method of the first aspect comprises the step of contacting a multilayer structure comprising a first layer and a second layer with an aqueous, homogeneous treatment solution comprising an organic solvent and water until the first layer is separated from the second layer, wherein the first layer comprises a polymer and the second layer comprises a non-polymer, wherein the polymer is soluble in the organic solvent and the polymer is insoluble in water.

According to a preferred embodiment, the method of the first aspect comprises the step of contacting a multilayer structure comprising a first layer and a second layer with an aqueous, homogeneous treatment solution comprising dihydrolevoglucosenone or isopropanol and water until the first layer is separated from the second layer, wherein the first layer comprises a polymer and the second layer comprises metal, wherein the polymer is soluble in dihydrolevoglucosenone or isopropanol and the polymer is insoluble in water.

According to a preferred embodiment, the method of the first aspect comprises the step of contacting a multilayer structure comprising a first layer and a second layer with an aqueous, homogeneous treatment solution having a temperature of from 15 to 90° C. until the first layer is separated from the second layer, wherein the first layer comprises a polymer selected from polyethylene, polypropylene, chloride, polyvinyl polyvinylidene chloride, polychlorotrifluoroethylene, ethylene vinyl acetate, ethylene vinyl alcohol, polyamide and polyethylene terephthalate and the second layer comprises aluminium, wherein the treatment solution comprises dihydrolevoglucosenone and water in a volume ratio of from 95:5 to 5:95.

According to a second aspect of the present invention, there is provided a separated layer prepared according to the method of the first aspect.

The separated layer may comprise the separated first layer, the separated second layer, and/or any further separated layer prepared according to the method of the first aspect. Suitably, the separated layer comprises only one layer separated and isolated from the multilayer structure.

For example, the separated layer may consist of the separated first layer or the separated second layer.

Suitable features of the separated layer are as described in relation to the first aspect.

The separated layer is suitably substantially free, preferably completely free of the treatment solution.

According to a third aspect of the present invention, there is provided an article comprising a separated layer according to the second aspect.

The article may be packaging, preferably multilayer packaging. The packaging suitably comprises a first separated layer according to the first aspect. Preferably the packing comprises a first separated layer and a second separated layer according to the first aspect.

According to a fourth aspect of the present invention, there is provided a use of a treatment solution comprising a solvent and a non-solvent for separating a first layer from a second layer in a multilayer structure, wherein the first layer comprises a polymer, wherein the polymer is soluble in the solvent and insoluble in the non-solvent.

Suitable features of the treatment solution and multilayer structure are as described in relation to the first aspect.

Preferably, the solvent comprises dihydrolevoglucosenone and the non-solvent comprises water.

Suitably, the treatment solution has a temperature above the glass transition temperature of the first polymer. The treatment solution suitably has a temperature above the glass transition temperature of any further polymers in the multilayer structure, such as the second polymer. The treatment solution suitably has a temperature below the boiling point of the solvent and the non-solvent.

The treatment solution suitably has a temperature of from 15 to 90° C., such as from 20 to 80° C., preferably from 55 to 75° C., for example 60 to 70° C.

### BRIEF DESCRIPTION OF THE DRAWINGS

For a better understanding of the invention, and to show how example embodiments may be carried into effect, reference will now be made to the accompanying drawings in which:

FIG. 1 shows general methodology according to an embodiment of the first aspect of the present invention.

FIG. 2 shows FT-IR spectra of a polymer before and after separation from blister packaging using a dihydrolevoglucosenone-water mixture.

FIG. 3 shows FT-IR spectra of a virgin polymer compared to a polymer recovered from blister packaging using a dihydrolevoglucosenone-water mixture.

FIG. 4 shows an FT-IR spectrum of a first polymer recovered from blister packaging using an isopropanol-water mixture.

FIG. 5 shows an FT-IR spectrum of a second polymer recovered from blister packaging using an isopropanol-water mixture.

FIG. 6 shows the FT-IR spectra of FIGS. 4 and 5 overlaid.

FIG. 7 shows a photograph of materials recovered from blister packaging after treatment with a dihydrolevoglucosenone-water mixture at a temperature of 22° C.

FIG. 8 shows FT-IR spectra of virgin polyvinyl chloride compared to a first polymer recovered from blister packaging under various conditions.

FIG. 9 shows FT-IR spectra of a second polymer recovered from blister packaging under various conditions.

FIG. 10 shows a photograph of materials recovered from blister packaging comprising printed ink after treatment with a dihydrolevoglucosenone-water mixture and filtration.

The invention will now be described with reference to the following non-limiting examples.

### EXAMPLES

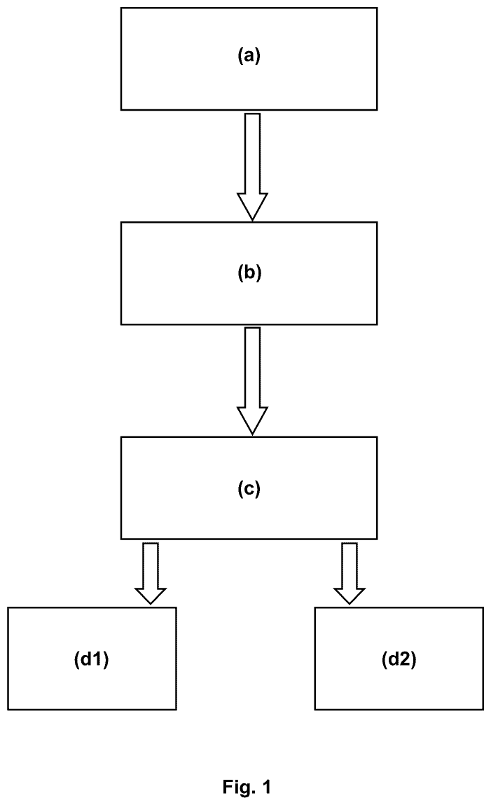

The method of the first aspect of the present invention may be carried out as shown in FIG. 1.

In step (a), multilayer packaging comprising a first layer and a second layer is provided. The first layer comprises a polymer, and the second layer suitably comprises a metal. The packaging may be cut into pieces.

Step (b) involves mixing the packaging with a treatment solution comprising a solvent and a non-solvent. This causes the first layer and the second layer to separate.

Step (c) involves removing the treatment solution from the separated first and second layers.

Step (d) involves isolating the separated first layer (d1) from the separated metal layer (d2).

This method advantageously allows separation and isolation of the first layer with minimal degradation of the polymer therein.

### Example 1

50 g of blister packaging material comprising a polymer layer and an aluminium layer was cut into small pieces (<15 mm) and mixed with 500 ml of a 70:30 dihydrolevoglucosenone-water mixture (i.e. wherein the volume ratio of dihydrolevoglucosenone to water is 70:30) in a closed glass reactor. The mixture was stirred mechanically using an overhead stirrer at 400 rpm at 60° C. for 6 hours, causing separation of the polymer layer and the aluminium layer. At the end of 6 hours, the solid and liquid materials were separated by vacuum filtration using filter paper. The solid material retained on the filter paper was collected and washed with water to remove the solvent. The solid material was then dried under vacuum and weighed. The layers of polymer and aluminium were isolated manually from the dried solid material.

The weight of recovered material is shown in Table 1. The result indicates the complete separation of the polymer layer from blister packaging waste material without any degradation.

TABLE 1
Recovery of material after treatment of blister packaging
with dihydrolevoglucosenone-water mixture

| Sample | Weight (g) |
|---|---|
| Blister packaging material used for experiment (g) | 50 |
| Recovered Aluminium layer (g) | 5 |
| Recovered Polymer layer (g) | 45 |

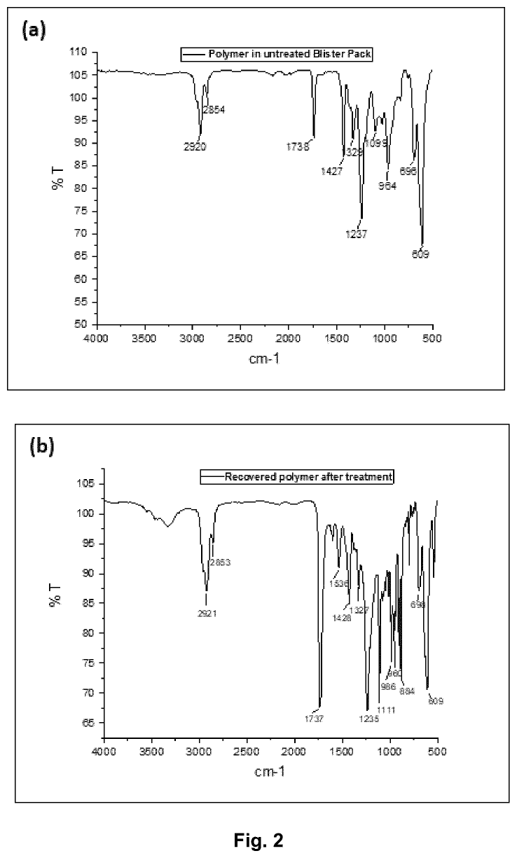

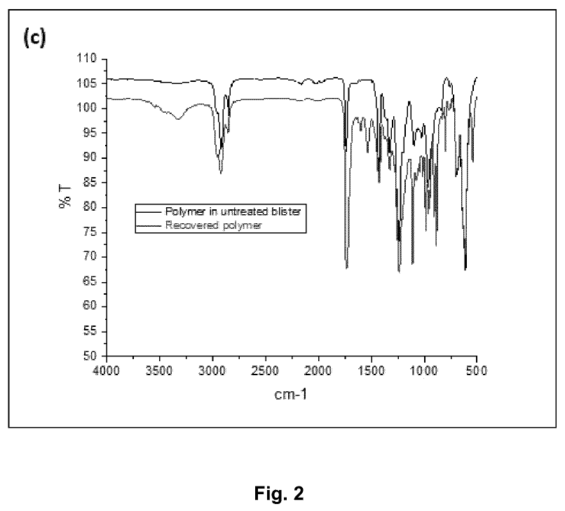

The polymer separated from the blister packaging material was characterised by Fourier-transform infrared spectroscopy (FT-IR) analysis. FT-IR spectra were recorded on a Perkin Elmer spectrophotometer in ATR mode in the wavelength range from 500 cm⁻¹ to 4000 cm⁻¹ with 16 scans and a resolution of 4 cm⁻¹. The FT-IR profile of the separated polymer was compared with that of polymer of untreated blister packaging material as shown in FIG. 2. FIG. 2(a) shows the profile of the untreated blister packaging, FIG. 2(b) shows the profile of the recovered polymer after treatment, and FIG. 2(c) shows a comparative profile which combines the profiles of (a) and (b). The recovered polymer showed similar characteristic peaks as the untreated blister polymer at wavelengths of 2920 cm⁻¹, 2854 cm⁻¹, 1738 cm⁻¹, 1427 cm⁻¹, 1329 cm⁻¹, 1237 cm⁻¹, 1099 cm⁻¹, 964 cm⁻¹, 696 cm⁻¹, and 609 cm⁻¹.

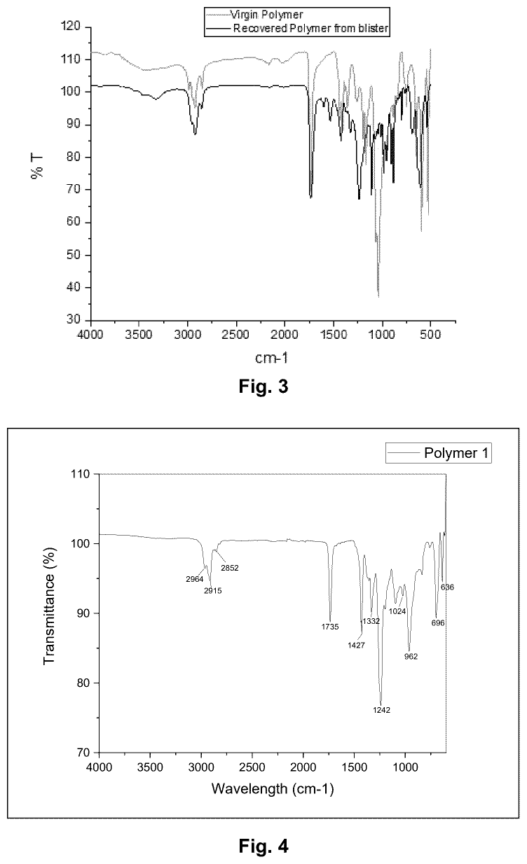

A similar observation was made when comparing the FT-IR spectra of the recovered polymer with virgin polymer used for blister packaging preparation, as shown in FIG. 3.

The FT-IR analysis confirms that the recovered polymer did not degrade during treatment of the blister packaging material.

### Example 2

Blister packaging material was treated with a dihydrolevoglucosenone-water mixture in the presence of a lipase enzyme to evaluate the separation of the polymer and metal layers. 1 g of blister packaging material cut into small pieces (<20 mm) was added into a 250 ML conical flask containing 100 mL of a 70:30 dihydrolevoglucosenone-water mixture to form a suspension. 1 mL of Candida antarctica lipase B enzyme (CAL B; enzyme activity 5000 lipase unit/g; equivalent to 1.2 g lipase having 6000 lipase units) was added to the suspension and hydrolysis was performed in an orbital shaker maintained at 60° C. and 200 rpm. Similarly, a control trial without the addition of an enzyme was conducted to evaluate the polymer separation from blister packaging waste.

Polymer layer separation from the aluminium layer was observed with and without the addition of lipase enzyme in the dihydrolevoglucosenone-water mixture. The separation of the polymer layer from the aluminium layer was observed at 5 hours and the reaction was further continued for 20 hours to evaluate polymer degradation. Table 2 shows the total weight of the starting material and the solid materials recovered after the experiments. There was no significant loss in the weight, which indicates that there was little or no polymer degradation with the lipase enzyme.

TABLE 2
Recovery of material after treatment of blister packaging with
dihydrolevoglucosenone-water mixture with and without enzyme

| Sample | Control trial | Trial with enzyme |
|---|---|---|
| Blister packaging material (g) | 1.01 | 1.02 |
| Total solid material recovered | 0.97 | 0.94 |
| after treatment (g) | | |

As no degradation was observed in the enzyme assisted hydrolysis of blister packaging material in a dihydrolevoglucosenone-water mixture, further optimisation would lead to a reduction in mixing time and solvent ratio used for the separation of the polymer layer.

### Example 3

g of crisp packet pieces (<40 mm) comprising a low-density polyethylene layer, a polypropylene layer and an aluminium layer were weighed and added into a glass reactor containing 200 mL of a 70:30 dihydrolevoglucosenone-water mixture to form a suspension. The suspension was mixed at 60° C. using an overhead stirrer at 400 rpm. The mixing was monitored to observe the separation of layers. The mixing of the crisp packet material in the dihydrolevoglucosenone-water mixture led to the separation of the polymer layers and the aluminium layer. After 5 hours of mixing, solid-liquid separation was performed using filtration to separate the solid polymer material from the solution. The low-density polyethylene layer, the polypropylene layer and the aluminium layer were isolated manually from the filtered solid material.

The amount of solid material recovered after the experiment is shown in Table 3 where P1 represents the polypropylene layer and P2 represents the low density polyethylene layer. This indicates no significant loss of material during the processing.

TABLE 3
Recovery of material after treatment of crisp packet
material with dihydrolevoglucosenone-water mixture

| Sample | Weight (g) |
|---|---|
| Crisp Packet material (g) | 20 |
| Separated polymer 1- P1 (g) | 13 |
| Separated polymer 2- P2 (g) | 4 |
| Metallic layer on filter paper (g) | 2 |

### Example 4

To evaluate the reusability of the used dihydrolevoglucosenone-water mixture, the mixture recovered in Example 1 was utilised to perform polymer separation. 20 g of blister packaging material pieces were suspended in a glass reactor containing 200 mL recovered dihydrolevoglucosenone-water mixture. The suspension was heated to 60° C. and mixed continuously using a mechanical overhead stirrer maintained at 400 rpm. The mixing was continued for 5 hours to separate the polymer layer from the aluminium layer in the packaging material. The solid material was recovered from the solution by filtration. The recovered solid material was washed with water to remove residual solvent and dried under vacuum. The layers of polymer and aluminium were isolated manually from the dried solid material.

The recovery of polymers and aluminium layers as shown in Table 4 indicates no significant loss. This confirms that the solvent-water mixture recovered after the experiment can be re-used for the polymer separation process without further purification and recovery.

TABLE 4
Recovery of polymers and aluminium layer from blister
packaging waste using recovered solvent mixture

| Sample | Weight |
|---|---|
| Blister packaging material used for experiment (g) | 20 |
| Recovered Aluminium layer (g) | 3 |
| Recovered Polymer layer (g) | 16 |

### Example 5

To evaluate the impact of the solvent, the polymer separation experiment was performed using an isopropanol-water mixture. 5 g of blister packaging material was cut into small pieces (<20 mm) and mixed with 500 mL of a 70:30 isopropanol-water mixture (i.e. wherein the volume ratio of isopropanol to water is 70:30) in a closed glass reactor. The mixture was stirred mechanically using an overhead stirrer at 400 rpm at 70° C. for 6 hours to separate the polymer layer from the aluminium layer. At the end of 6 hours, the solid and liquid materials were separated by filtration on a Buchner funnel. The solid material retained on a Buchner funnel was collected and washed with water to remove the solvent. The solid material was then dried under a vacuum and weighed. The layers of polymer and aluminium were isolated manually from the dried solid material. It was observed that two different types of polymer layer were present in the recovered polymer layer and these were separated manually.

The weight of recovered material is shown in Table 5. The result indicates complete separation of layers in the blister packaging material and that there was no significant loss of the material during processing.

TABLE 5
Recovery of material after treatment of blister
packaging with isopropanol-water mixture

| Sample | Weight (g) |
|---|---|
| Blister packaging material used for experiment (g) | 5 |
| Recovered Polymer layer P1 (g) | 3.76 |
| Recovered Polymer layer P2 (g) | 0.42 |
| Recovered aluminium layer (g) | 0.62 |

The two types of polymer layer recovered were analysed using FT-IR. FT-IR spectra were recorded on a Perkin Elmer spectrophotometer in ATR mode in the wavelength range from 500 cm⁻¹ to 4000 cm⁻¹ with 16 scans and a resolution of 4 cm⁻¹. FIGS. 4 and 5 show the FT-IR spectra of polymer 1 (P1) and polymer 2 (P2) respectively.

The spectrum of polymer 1 in FIG. 4 indicates the presence of peak at wavelengths of 2915 cm⁻¹, 2852 cm⁻¹ (C—H stretch), 1735 cm⁻¹ (C—H stretch, 1427 cm⁻¹ (C—H bend), 1332 cm⁻¹ (C—H) bend, 1242 cm⁻¹ (C—H bend), 1024 cm⁻¹ (C—C stretch), 962 cm⁻¹ (C—H rock) and 636-696 cm⁻¹ (C—Cl stretch) corresponding to the spectrum of polyvinyl chloride (PVC).

The spectrum of polymer 2 in FIG. 5 shows characteristic peaks of polyurethane. It shows the presence of peaks at wavelengths of 3332 cm⁻¹ (N—H stretch), 2950 cm⁻¹, 2867 cm⁻¹ (C—H stretch), 1730 cm⁻¹ (C═O stretch), 1537 cm⁻¹ (C—H stretch), 1226 cm⁻¹ (C—N stretch), and 1041 cm⁻¹ (C—O—C stretch).

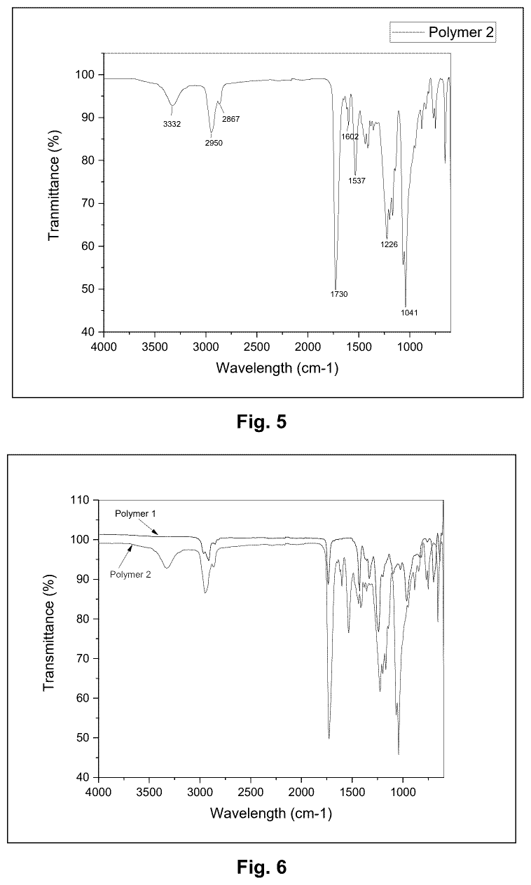

The overlaid spectra in FIG. 6 shows the difference between polymer 1 and polymer 2 recovered from the blister packaging using the isopropanol-water mixture. This confirms that the two polymer layers recovered were not the same. This further demonstrates that use of the isopropanol-water mixture leads to the complete separation of each layer of polymer and metal.

### Example 6

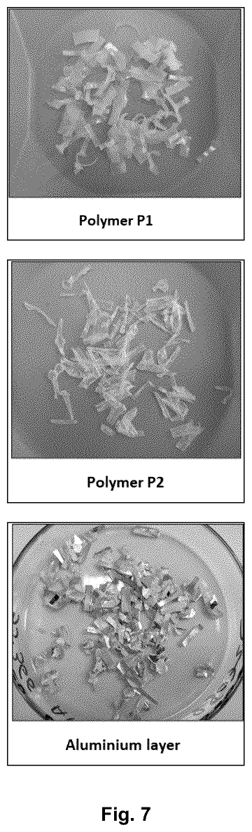

2 g of blister packaging material pieces (<20 mm) was mixed with 200 ml of a 70:30 dihydrolevoglucosenone-water mixture (i.e. wherein the volume ratio of dihydrolevoglucosenone-water mixture is 70:30) in a closed glass reactor. The mixture was stirred mechanically using an overhead stirrer at 400 rpm at 22° C. for 96 hours to separate the polymer layer from the aluminium layer. At the end of 96 hours, the solid and liquid materials were separated by filtration on a Buchner funnel. The solid material retained on a Buchner funnel was collected and washed with water to remove the solvent. The solid material was then dried under a vacuum and weighed. The layers of polymer and aluminium were isolated manually from the dried solid material. It was observed that two different types of polymer layer were present in the recovered polymer layer. FIG. 7 shows the recovered layers.

The weight of recovered material is shown in Table 6. The result indicates complete separation of layers in the blister packaging material and that there was no loss of the material during processing.

TABLE 6
Recovery of material after treatment of blister packaging
with dihydrolevoglucosenone-water mixture at 22° C.

| Sample | Weight (g) |
|---|---|
| Blister packaging material used for experiment (g) | 2 |
| Recovered Polymer layer P1 (g) | 1.52 |
| Recovered Polymer layer P2 (g) | 0.19 |
| Recovered aluminium layer (g) | 0.29 |

The two types of polymer layer recovered were analysed using FT-IR. FT-IR spectra were recorded on a Perkin Elmer spectrophotometer in ATR mode in the wavelength range from 500 cm⁻¹ to 4000 cm⁻¹ with 16 scans and a resolution of 4 cm⁻¹.

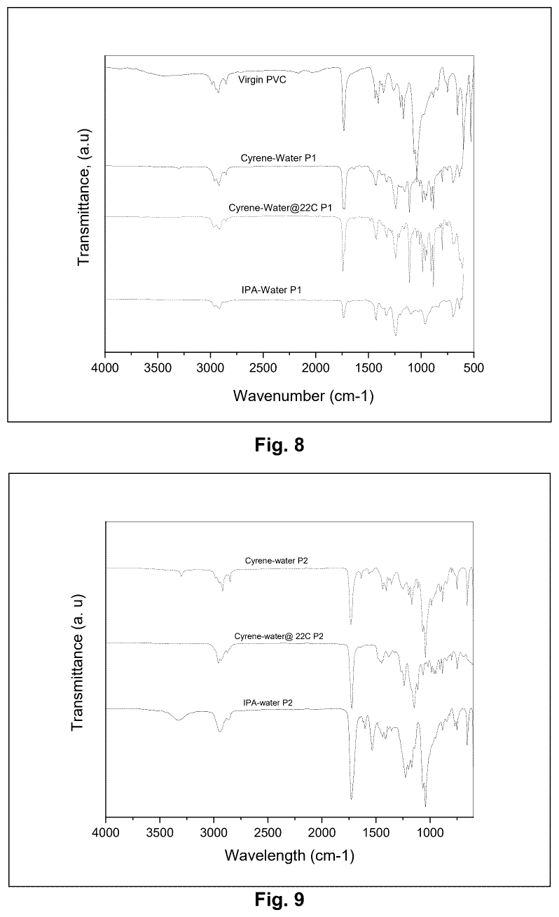

FIG. 8 shows FT-IR spectra of virgin polyvinyl chloride (PVC), polymer layer 1 recovered under the conditions of Example 1 (“Cyrene-Water P1”); polymer layer 1 recovered under the conditions of Example 6 (“Cyrene-Water@22C P1”); and polymer layer 1 recovered under the conditions of Example 5 (“IPA-Water P1”). The spectra indicate that the recovered polymer film is similar to virgin PVC film.

FIG. 9 shows FT-IR spectra of polymer layer 2 recovered under the conditions of Example 1 (“Cyrene-Water P2”); polymer layer 2 recovered under the conditions of Example 6 (“Cyrene-Water@22C P2”); and polymer layer 2 recovered under the conditions of Example 5 (“IPA-Water P2”). The spectra show similar characteristic peaks as that of polyurethane.

### Example 7

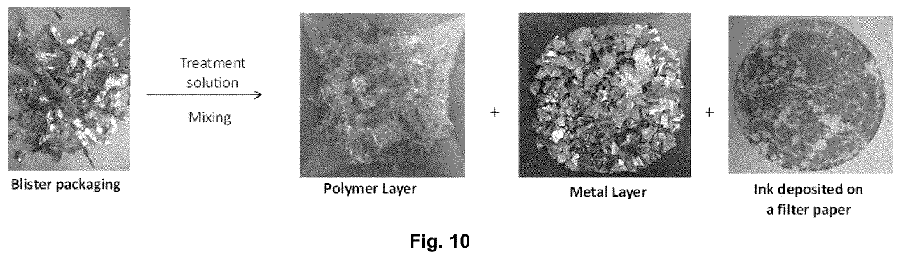

50 g of blister packaging material pieces (<20 mm) comprising printed ink was mixed with 500 mL of a 70:30 dihydrolevoglucosenone-water mixture (i.e. wherein the volume ratio of dihydrolevoglucosenone-water mixture is 70:30) in a closed glass reactor. The mixture was stirred mechanically using an overhead stirrer at 400 rpm at 60° C. for 6 hours to remove the printed inks on the metal surface while separating the polymer and aluminium layer. At the end of 6 hours, the solid and liquid materials were separated by filtration. The recovered liquid was grey and was further filtered using Whatman filter paper to recover the inks suspended in the treatment solution. After this step, the recovered treatment solution was dark yellow, showing that the inks had been removed. FIG. 10 shows the various recovered layers and pigments recovered from the separation process.

The example embodiments described above may provide a method of separating a polymer from a multilayer structure which does not dissolve or degrade the polymer. The method may be carried out under mild conditions using an environmentally friendly solvent mixture which itself may be recovered and reused.

In summary, a method for separating a first layer from a second layer in a multilayer structure is disclosed. The method comprises the step of contacting the multilayer structure with a treatment solution comprising a solvent and a non-solvent until the first layer is separated from the second layer. The first layer comprises a polymer, wherein the polymer is soluble in the solvent and the polymer is insoluble in the non-solvent. The separated layer, an article comprising the separated layer, and a use of the treatment solution to separate the first layer from the second layer in the multilayer structure are also disclosed.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

By “substantially free”, it is meant that a composition (such as a treatment solution or a separated layer) does not comprise more than a trace amount of a component. The composition suitably comprises the component in an amount of less than 1 wt %, such as less than 0.1 wt %, for example less than 0.01 wt % based on the total weight of the composition.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method for separating a first layer from a second layer in a multilayer structure, the method comprising the steps of providing a multilayer structure having at least two layers including a first layer and a second layer, and contacting the multilayer structure with a treatment solution comprising a solvent and a non-solvent until the first layer is separated from the second layer, wherein the first layer comprises a polymer, wherein the polymer is soluble in the solvent and the polymer is insoluble in the non-solvent.

2. The method of claim 1, wherein the polymer is selected from polyethylene, polypropylene, polyvinyl chloride, polyvinylidene chloride, polychlorotrifluoroethylene, ethylene vinyl acetate, ethylene vinyl alcohol, polyamide or polyethylene terephthalate.

3. The method of claim 1, wherein the second layer comprises a polymer.

4. The method of claim 1, wherein the second layer comprises a non-polymer, wherein the non-polymer comprises metal or paper.

5. The method of claim 4, wherein the metal comprises aluminium.

6. The method of claim 1, wherein the multilayer structure comprises an adhesive layer.

7. The method of claim 1, wherein the treatment solution is an aqueous, homogenous solution.

8. The method of claim 1, wherein the solvent comprises dihydrolevoglucosenone and the non-solvent comprises water.

9. The method of claim 1, wherein the treatment solution comprises the solvent and the non-solvent in a volume ratio of from 95:5 to 5:95.

10. The method of claim 1, wherein the treatment solution further comprises an enzyme.

11. The method of claim 1, wherein the treatment solution contacted with the multilayer structure has a temperature of from 15 to 90° C.

12. The method of claim 1, further comprising the step of removing the treatment solution from the separated first layer and the separated second layer.

13. The method of claim 12, further comprising reusing the removed treatment solution.

14. A separated layer prepared according to the method of claim 1.

15. An article comprising a separated layer according to claim 14.

16. Use of a treatment solution comprising a solvent and a non-solvent for separating a first layer from a second layer in a multilayer structure, wherein the first layer comprises a polymer, wherein the polymer is soluble in the solvent and insoluble in the non-solvent.
